(19) United States
(12) Patent Application Publication
(10) Pub. No.: US 2018/0082505 A1
(43) Pub. Date: Mar. 22, 2018

(54) ACTIVE COIN CONTROL DEVICE

(71) Applicant: Crane Payment Innovations, Inc., Malvern, PA (US)

(72) Inventors: Michael David Nunn, West Chester, PA (US); William Martin Osborne, West Chester, PA (US)

(21) Appl. No.: 15/563,558

(22) PCT Filed: Apr. 1, 2016
(86) PCT No.: PCT/US2016/025762

§ 371 Date: Sep. 29, 2017

Related U.S. Application Data
(60) Provisional application No. 62/141,631, filed on Apr. 1, 2015.

(51) Int. Cl. G07D 5/08; G07F 1/04; G07D 3/14; G07D 11/00

(52) U.S. Cl. CPC G07D 5/08; G07D 11/0036; G07D 3/14; G07F 1/048

(57) ABSTRACT

An embodiment of this disclosure provides an apparatus, including a control blade configured to move by rotating or translating. The apparatus also includes a magnet coupled to the control blade. The apparatus also includes an electric coil. The magnet is positioned such that movement of the control blade causes the magnet to influence an electromagnetic field of the electric coil.

### CROSS-REFERENCE TO RELATED APPLICATION

The present application claims priority under 35 U.S.C. § 365 to International Patent Application No. PCT/US2016/025762 filed Apr. 1, 2016, entitled “ACTIVE COIN CONTROL DEVICE”. International Patent Application No. PCT/US2016/025762 claims priority under 35 U.S.C. § 365 and/or 35 U.S.C. § 119(e) to U.S. Provisional Patent Application No. 62/141,631 filed Apr. 1, 2015, each of which is incorporated herein by reference into the present disclosure as if fully set forth herein.

### TECHNICAL FIELD

The present application relates generally to electronic transaction systems and, more specifically, to a coin recognition system of an electronic transaction system.

### BACKGROUND

Various machines and devices are known for accepting items of currency in exchange for goods and services. Previously these devices had no control over the force of a coin and the device would need to be compromised in order to perform well for both large and small coins. Large coins would travel too quickly through the sensors with too much wobble such that the sensor readings were poor quality and small coins would often stop in the coin path, particularly if the path was wet or dirty.

### SUMMARY

An embodiment of this disclosure provides an apparatus, including a control blade configured to move by rotating or translating. The apparatus also includes a magnet coupled to the control blade. The apparatus also includes an electric coil. The magnet is positioned such that movement of the control blade causes the magnet to influence an electromagnetic field of the electric coil.

Another embodiment of this disclosure provides a method for controlling a coin mechanism. The method includes receiving an amount of an electric current from a sensor indicating a movement by rotation or translation of a control blade. The electric current is produced from an electric coil when a magnet coupled to the control blade influences an electromagnetic field of the electric coil. The method also includes controlling the movement of the control blade using an interaction between the magnet and the electric coil.

Yet another embodiment of this disclosure provides a coin recognition system. The coin recognition system includes an enclosure including a payment access mechanism, wherein the payment access mechanism comprises a coin mechanism. The coin mechanism includes a control blade configured to move by rotation or translation. The coin mechanism also includes a magnet coupled to the control blade. The coin mechanism also includes an electric coil. The magnet is positioned such that movement of the control blade causes the magnet to pass influence an electromagnetic field of the electric coil.

Other technical features may be readily apparent to one skilled in the art from the following figures, descriptions, and claims. Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases may be provided throughout this patent document, and those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a simplified perspective view illustrating a vending machine implementing an example coin recognition system to one embodiment of the present disclosure

FIG. 2 illustrates an example coin validator implementing an improved coin control system according to one embodiment of the present disclosure;

FIG. 3 is a perspective view illustrating an example coin control mechanism according to this disclosure;

FIG. 4 is a perspective view illustrating an example coin control system with a magnet according to this disclosure;

FIG. 5 illustrates an example process to operate a coin control system according to this disclosure; and

FIG. 6 illustrates an example computing device supporting various functions according to this disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### DETAILED DESCRIPTION

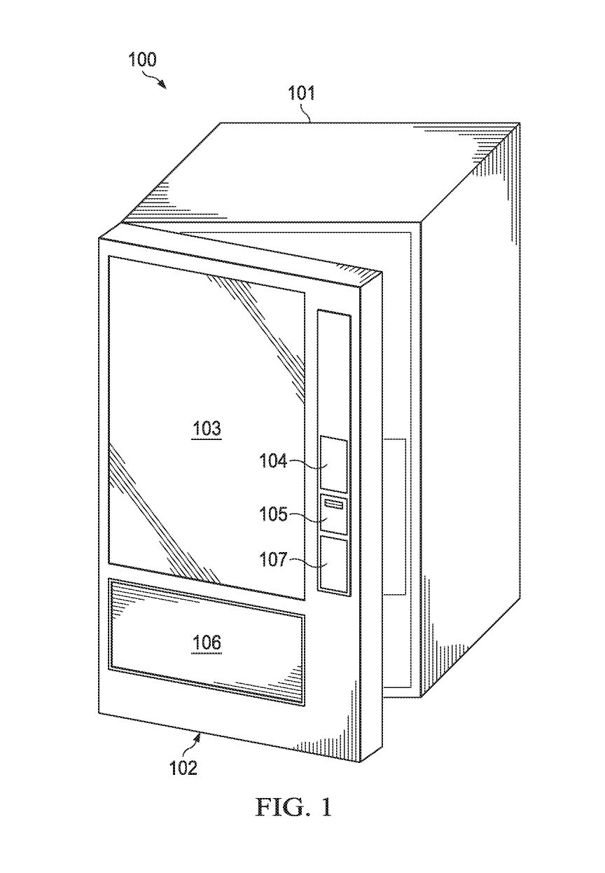

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine, automatic ticket seller machine, gaming machine, automated payment machine, automatic teller machine or any other currency handling system.

Electronic transaction systems, such as automatic ticket seller machine, automatic teller machine, vending machine, gaming machine and other kiosks are provided at attended and unattended places to provide ease and flexibility to a user to performing transactions in return for goods or services. Electronic transaction systems often accept coins for payment of goods or services. A coin recognition/reception system (herein after “coin recognition system”) is used by electronic transaction systems to receive coins for such payment. The coin recognition system includes a coin control system. The coin control system includes a swing blade or coin control blade that enters a coin travel path of a coin mechanism (also referred to as a coin recognition system) to reduce the amount of energy that the coin possesses before the coin reaches one or more sensors. Coins can refer to coin currency, tokens, chips, or the like.

FIG. 1 is a simplified perspective view illustrating a vending machine 100 implementing an improved coin recognition system according to one embodiment of the present disclosure. FIG. 1 illustrates an example vending machine 100 according to various embodiments of the present disclosure. Vending machines come in a wide variety of configurations, and FIG. 1 does not limit the scope of this disclosure to any particular implementation of a vending machine. Additionally, embodiments of this disclosure may be implemented in automatic ticket seller machines, gaming machine, automated payment machine, automatic teller machines, kiosks, and the like, and are not limited to use in only vending machines.

Vending machine 100 includes a cabinet 101 and a service door 102 that, together, define an enclosure. In the embodiment illustrated, the service door 102 is pivotally mounted to the front of the cabinet 101 and extends all the way across the front face of the vending machine 100. In alternate designs, the service door may extend only part way across the front of the vending machine, or may be formed in two portions (of equal or unequal sizes) that swing open in opposite directions.

In the embodiment illustrated in FIG. 1, the service door 102 includes a transparent front 103 allowing the customer to view actual products available for vending, which may include snacks, packaged beverages, or both.

Vending machine 100 also includes a customer product selection interface 104, payment access mechanism 105 and a delivery bin door 106. Customer product selection interface 104, which could be a touch-screen liquid crystal display (LCD) display and input, is instead in the present disclosure an alternate extended keypad design compatible with expanded vend transaction processing, as described in further detail below.

Payment access mechanism 105 may include one or more of a coin slot allowing deposit of coins into a coin mechanism (or coin recognition system), a banknote access slot for feeding paper currency into a banknote validator and/or recycler, and a magnetic stripe swipe mechanism for reading the magnetic stripe on credit or debit cards.

The vending machine 100 includes a delivery bin door 106 positioned below the transparent window 103 and substantially across the width of the product columns behind the transparent window. Products available for vending are thus held in, for example, helical coils on shelves visible from the exterior through the transparent window 103 and are dropped through a space between the shelves and the transparent window 103 into the delivery bin behind delivery bin door 106. Those skilled in the art will recognize that in some vending machines, particularly beverage vending machines, an X-Y product retrieval and delivery mechanism delivers vended product to an access port to the side as shown in FIG. 1, at a height convenient to the customer for product retrieval without bending over.

In one example embodiment, the payment access mechanism 105 may be coupled to a coin return recess 107. Any resulting change from the transaction may be paid out through the coin return recess 107.

Those skilled in the art will recognize that the complete structure of a vending machine is not depicted in the drawings, and the complete details of the structure and operation of the vending machine is not described herein. Instead, for simplicity and clarity, only so much of the structure and operation of a vending machine as is unique to the present disclosure or necessary for an understanding of the present invention is depicted and described.

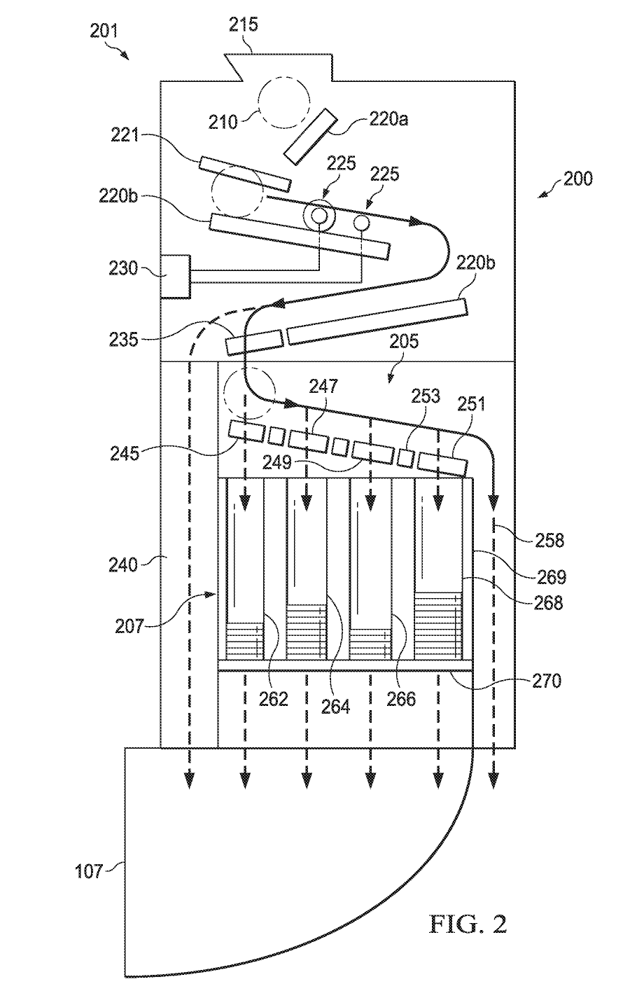

FIG. 2 illustrates an example coin validator 201 implementing an improved coin control system 221 according to one embodiment of the present disclosure. In one illustrative embodiment, coin validator 201 can be part of coin access mechanism 105 of FIG. 1. FIG. 2 illustrates an example coin validator 201 according to various embodiments of the present disclosure. Coin validators come in a wide variety of configurations, and FIG. 2 does not limit the scope of this disclosure to any particular implementation of a coin validator. Additionally, embodiments of this disclosure may be implemented in automatic ticket seller machines, gaming machine, automated payment machine, automatic teller machines, kiosks, and the like, and are not limited to use in only vending machines.

Referring to FIG. 2, coin validator 201 comprises a coin recognition system 200, a coin separator 205 and a coin storage region 207. The coin validator 201 receives an inserted coin 210 through an opening 215, which is connected to payment access mechanism 105. The coin 210 travels along ramp 220 in the coin validator 201 past sensors such as those shown at 225. Between ramp 220a and 220b, a coin control system 221 may control the force or speed of the coin 210. In different embodiments, the coin control system 221 can be positioned in different places within coin validator 201. For example, coin control system 221 could be before 220a so that coin 210 travels past the coin control system 221 before travelling along ramp 220a.

The sensors 225 generate electrical signals which are provided to a coin mechanism processor 230 such as a microprocessor or microcontroller. The electrical signals generated by the sensors 225 contain information corresponding to the measured characteristics of the coin, such as a coin's diameter, thickness, metal content, and electromagnetic properties. Based on these electrical signals, the processor 230 is able to discriminate whether the coin is acceptable, and if so, the denomination of the coin 210.

If the coin 210 is unacceptable, the processor 230 controls a gate 235 to direct the unacceptable coin 210 to a reject chute 240. The reject chute 240 is connected to the coin return recess 107 of FIGS. 1 and 2. In the alternative, acceptable coins 210 are directed to the coin separator 205 by the gate 235. The coin separator 205 may have a number of gates 245, 247, 249, 251 arranged along a ramp 253 and also controlled by signals from the processor 230, for diverting the coin 210 from the ramp 253. The coin 210 may be diverted into respective containers 262, 264, 266 and 268, or the coin 210 may be allowed to proceed along ramp 253 to a path 258 leading to a cash box (not shown).

Each of the containers 262, 264, 266 and 268 is in the form of a coin tube arranged to store a vertical stack of coins of a particular denomination. Although only four containers are shown, any number may be provided. The coin tubes may be arranged within a removable cassette 269.

A dispenser 270 associated with the coin tubes 262-268 is operable to dispense coins from the containers when change is to be given to a customer by the coin validator 201. The dispensed coins are delivered to the coin return recess 107 for collection.

Those skilled in the art will recognize that the complete structure of a coin validator 201 is not depicted in the drawings, and the complete details of the structure and operation of the coin validator 201 is not described herein. Instead, for simplicity and clarity, only so much of the structure and operation of a coin validator 201 as is unique to the present disclosure or necessary for an understanding of the present invention is depicted and described.

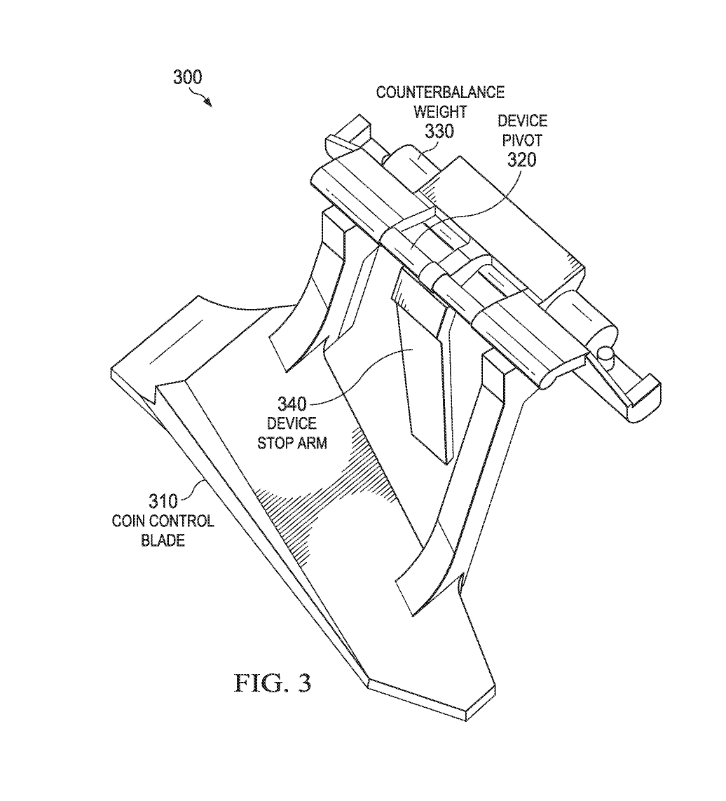

FIG. 3 is a perspective view illustrating an example coin control mechanism 300 according to this disclosure. FIG. 3 illustrates an example coin control mechanism 300 according to various embodiments of the present disclosure. Coin control mechanisms come in a wide variety of configurations, and FIG. 3 does not limit the scope of this disclosure to any particular implementation of a coin control mechanism. Additionally, coin control mechanism may be one example of a coin mechanism that is part of payment access mechanism 105 of FIG. 1.

In FIG. 3, the coin control mechanism 300 includes a coin control blade 310 that engages with a coin when the coin is inserted through a slot of the coin recognition system 200. As a coin engages with the coin control blade 310, the coin pushes (for example, by the weight of the coin or by a force behind the coin) the control blade 310 out of a coin travel path so that the coin can pass through the coin travel path of the coin recognition system 200. The coin control blade 310 moves out of the coin travel path by pivoting around a device pivot 320.

In one or more example embodiments, the coin control mechanism 300 also includes a counterbalance weight 330 and a stop arm 340. The counterbalance weight 330 is a counterbalance to hold the coin control blade 310 in the coin travel path when a coin is not engaging the coin control blade 310. For example, the counterbalance weight 330 keeps the coin control blade 310 in a normally closed position so that the coin control blade 310 rests in the coin travel path or blocks the coin travel path.

The stop arm 340 can be fixedly attached to the coin control blade 310 or to one or more other components of the coin recognition system 200 that is fixedly attached to the coin control blade 310. In one example, the stop arm 340 extends from the device pivot 320 at an angle offset from the coin control blade 310. In other examples, the stop arm 340 may not be offset.

In one example embodiment, as a coin engages with the coin control blade 310 causing the coin control blade 310 pivots around the device pivot 320, the stop arm 340 also pivots around the device pivot 320 with the coin control blade 310. The stop arm 340 pivots around the device pivot 320 with the coin control blade 310 until the stop arm 340 engages a fixed surface of the electronic transaction system. When the stop arm 340 engages the fixed surface of the coin recognition system 200 preventing the stop arm 340 from further rotation around the device pivot 320, the coin control blade 310 fixedly coupled with the stop arm 340 also stops rotating further around the device pivot 320. The stop arm 340 prevents the coin control blade 310 from pivoting too far around the device pivot 320 and prevents contact between the coin control blade 310 and another component of the coin recognition system 200. The stop arm 340 can be flexible providing at least some rebound effect when contacting a surface as discussed herein.

One or more embodiments of this disclosure provide that the speed of the arm due to the impact of the coin would be an indicator of the amount of energy that the coin possessed and by measurement of the current induced in the coil the amount of energy could be quantified and used to determine the appropriate reaction that was required to control it. The swing of the arm can be damped by controlling the current in the coil to provide a resistance on the moving magnet. The device could be used to push against the coin with sufficient force to stop any unwanted motion. Once the coin was under control the device could be lifted away from the coin to make sure that even the smallest coins would not get trapped under it. The device can be a ‘wake-up’ sensor—since the initial current is generated by the coin, the system could be in a low power mode until it saw the input current.

One or more embodiments of this disclosure recognize and take into account that when coins enter a coin mechanism, the coins have a lot of kinetic energy and various devices are used to control the energy so that the coin is under more control before it travels through the coin sensors. A coin control device can take the form of a swinging blade in the coin path. The coin control device can include a counter balance on the back of the device which is tuned to provide the correct amount of reaction to control the coin but not so much force as to stop the coin from rolling. There are a number of problems with this mechanism since coins have many different sizes and various amounts of kinetic energy and all must be controlled using one device. At one extreme large, heavy or fast coins can force their way through the device resulting in poor validation and at the other small, light or slow coins can stop in the coin path which would then require rejection from the unit.

One or more embodiments of this disclosure provide a permanent magnet fixed to a swinging blade similar to the above design and an electrical coil attached to the fixed housing surrounding the moving path of the magnet. Information can be gathered by the measuring the current induced in the coil by impact from coins and force applied by an electrical current in the coil can be used to control the reaction force applied to the coin. This will make it an ‘active’ device which could be controlled so that the response of the system can be varied to be appropriate for whichever type of coin was encountered. Thus a larger range of coins can be controlled more effectively than with an uncontrolled swinging arm and fewer coins would need to be rejected due to stalling in the unit. In one or more embodiments, the swing blade could have an electrical coil attached to the swing blade and a magnet attached to the fixed housing surrounding the moving path of the electrical coil.

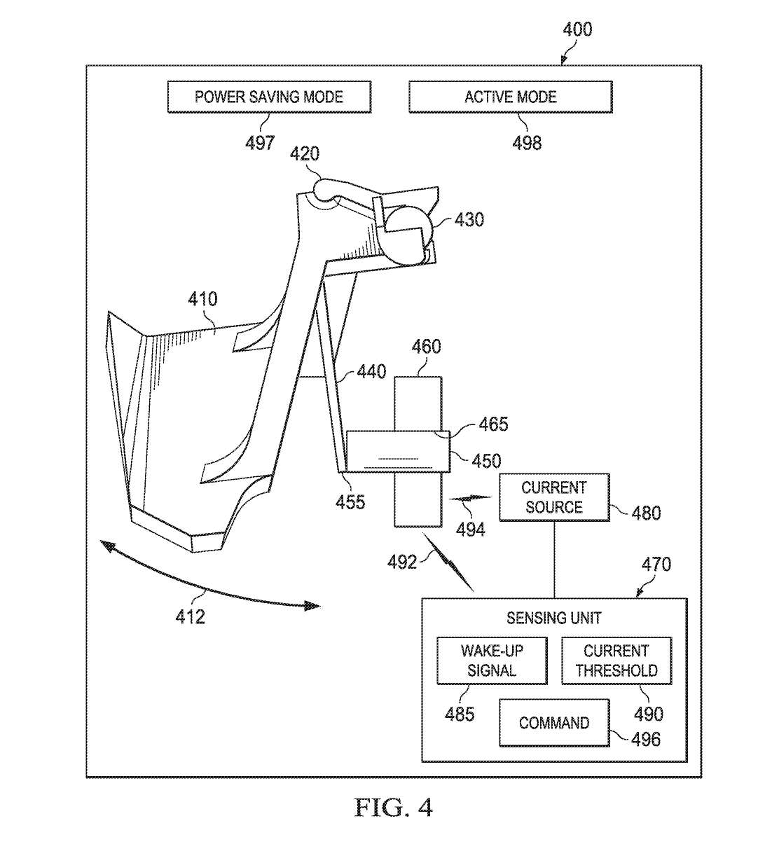

FIG. 4 is a perspective view illustrating an example coin control system 400 with a magnet 450 according to this disclosure. FIG. 4 illustrates an example coin control system 400 according to various embodiments of the present disclosure. Coin control system 400 can be one example of coin control system 221 of FIG. 2. Coin control systems come in a wide variety of configurations, and FIG. 4 does not limit the scope of this disclosure to any particular implementation of a coin control system. Additionally, coin control system may be one example of a coin mechanism that is part of coin validator 201 of FIG. 2.

In FIG. 4, the coin control system 400 includes the coin control blade 410, the device pivot 420, and the counterbalance weight 430 as discussed herein. In some cases, the counterbalance weight 430 may not be implemented with the coin control system 400. The coin control system 400 also includes a stop arm 440. The stop arm 440 is similar to the stop arm 440 illustrated in FIG. 4. For example, the stop arm 440 is fixedly attached to the coin control blade 410 or to one or more other components of the coin control system 400 that is fixedly attached to the coin control blade 410. The stop arm 440 extends from the device pivot 420 at an angle offset from the coin control blade 410. The stop arm 440 also pivots around the device pivot 420 as the coin control blade 410 pivots around the device pivot 420. The stop arm 440 can be flexible providing at least some rebound effect or the stop arm 440 can be rigid providing greater strength and support for example for supporting a magnet.

Furthermore, it should be understood that a device pivot 420 can be substituted with or used in conjunction with other movement permitting devices. For example, the stop arm 440 can be used with a movement device that allows the stop arm 440 to move linearly such as a sliding or extending motion. The stop arm 440 can also be used with one or more movement devices that allow the stop arm 440 to move in a compound motion such as a movement with a change in direction using both linear movement devices (such as sliding or extending device) and rotational movement devices (such as the pivot device 420). Pivoting using a rotational movement device is in directions 412. In yet another embodiment, when the pivot device 420 is a linear movement device, coin control blade 410 can translate along a channel, bar, sliding device, or extending device. The translation could be any direction allowable by the channel, bar, sliding device, or other extending device.

In one or more embodiments, the stop arm 440 also includes a magnet 450. In one example, the magnet 450 is a permanent magnet. The magnet 450 is disposed on a distal end 455 of the stop arm 440 opposite from the device pivot 420. In an embodiment, the magnet 450 can be located at any position on the stop arm 440 such that the magnet 450 can be received by or communicated at least partially through the coil 460. In one example embodiment, magnet 450 may influence the magnetic field and therefore the electromagnetic field of the electric coil 460 without penetrating the electrical coil 460. In one embodiment, the magnet 450 is an electromagnet and wrapped around a solid core. In another embodiment, the magnet is a solenoid 450. In additional embodiments, the magnet 450 may be multiple magnets of different types of magnets or the same type.

The magnet 450 disposed on the stop arm 440 is configured to pass through at least a portion of a coil passage formed by a coil 460. The coil 460 can have a cylindrical shape with openings at each end forming a passage or any other shape that can for a passage and allow and of an arm to pass through. In one or more embodiments, the electric coil 460 could be an electromagnet with a solid core. In an embodiment, the magnet 450 can be swapped with the electric coil 460 such that the electric coil 460 coupled to the stop arm 440 is received by the magnet 450. In different embodiments, different configurations between the magnet 450 and electric coil 460 can exist. Such as, for example, for example an electromagnet with a steel core could work in some aspects of the functionality, two coils instead of a coil and a magnet could function to repel the device, and the like.

In one embodiment, in a resting position when the coin control blade 410 is blocking or at least partially obstructing a coin travel path, the magnet 450 is located a distance (such as a linear or radial distance) from an opening of the coil passage 465 created by the coil 460. When a coin engages the coin control blade 410 and the coin control blade 410 pivots or rotates around the device pivot 420, at least a portion of the magnet 450 passes through the opening of the coil passage 465 formed by the coil 460 generating an electric current through the coil 460. In an embodiment, the magnet 450 can already be inside the coil passage 465 of the coil 460 and can be moved further through the coil passage of the coil 460 when a coin engages the coin control blade 410. In one or more embodiments, the electric coil 460 could be an electromagnet with a solid core without a passage. When there is no passage, the magnet does not penetrate the coil, but instead influences the magnetic field around the coil by passing near the coil.

In one example embodiment, when the magnet is a solenoid, the passage 465 could be through the core of the magnet. In another embodiment, the coil 460 may include two coils connected by a straight portion of wire where the passage 465 is between the two coils. In yet another embodiment, the passage 465 may be between two separate coils.

In various embodiments, the coil 460 is electrically coupled to a sensing unit 470. The sensing unit 470 can include one or more sensors and a process, controller, and/or processing circuitry. In another embodiment, the sensing unit 470 is only a sensor, and the sensor is connected to another processor. The sensing unit 470 senses when an electric current 492 is generated through the coil 460. To save power, the coin control system 400 may have an off-mode or a power saving mode 497 and may only enter an active mode 498 at a time when the coin control system 400 is being used.

When the magnet 450 passes through an opening of the coil passage formed by the coil 460 and an electric current 492 is generated through the coil 460, the sensing unit 470 senses the electric current 492 and generates a wake-up signal 485 to command 496 the coin control system 400 or vending machine 100 in FIG. 1 to enter an active mode from an off-mode or a power saving mode 497 (for example, when providing power for essential, necessary, or core functions of the coin control system 400). In an embodiment, the sensing unit 470 generates the wake-up signal 485 when the sensing unit 470 senses an amount of electric current 492 that exceeds a threshold 490. In some embodiments, the magnet 450 could influence the magnetic field in the electric coil 460 without penetrating the electric coil 460.

As discussed, the sensing unit 470 senses an amount of electric current 492 generated through the coil 460. The velocity of the magnet 450 passing through the coil passage formed by the coil 460 affects the electric current through the coil 460. If a large coin engages the coin control blade 410, the weight of the large coin can cause the magnet to pass faster through the coil passage formed by the coil 460 than the weight of a smaller coin. The faster the magnet 450 passes through the coil passage 465 formed by the coil 460 the greater the electric current 492 generated through the coil 460. In some embodiments, the relative movement of the magnet 450 could influence the magnetic field in the electric coil 460 without penetrating the electric coil 460.

The sensing unit 470 determines an appropriate reaction based on the amount of electric current 492 passing through the coil 460. For example, the sensing unit 470 commands 496 an electric current source 480 to generate a counter electric current 494 through the coil 460 to dampen a speed of the magnet 450 through the coil passage 465 or to push the magnet 450 back out of the coil passage 465. The amount of electric current 494 generated through the coil by the electric current source 480 can be determined by the amount of electric current 492 generated by the magnet 450 and sensed by the sensing unit 470. In some embodiments, the sensing unit 470 commands 496 an electric current source 480 to generate a counter electric current through the electric coil 460 to dampen a speed of the magnet 450 without penetrating the electric coil 460.

In an embodiment, the sensing unit 470 can use the amount of electric current 492 to identify a type of coin. For example, the amount of electric current may identify a size and/or weight of a coin, which can be used to identify a specific coin. For example, a quarter may have a cause a greater amount of electric current than a dime.

The coil 460 is electrically coupled to the electric current source 480. The electric current source 480 generates an electric current through the coil 460 during both an active mode and power-saving mode 497, during only an active mode 498, or when receiving a command 496 from a sensing unit 470. The electric current source 480 generates an electric current 494 to counter an electric current 492 generated through the coil 460 when the magnet 450 passes through the coil passage 465 to dampen or stop further movement of the coin control blade 410. In some embodiments, the electric current source 480 generates an electric current 494 to counter an electric current 492 generated through the electric coil 460 when the magnet 450 influences the electric coil 460 without penetrating the electric coil 460. The electric current source 480 generates an electric current 494 through the coil 460 after a coin is under control of the coin control system 400 in order to lift the coin control blade 410 away from the coin to ensure that even the smallest coin does not get trapped under or within the coin control blade 410.

The sensing unit 470 and the electric current source 480 can be electrically coupled to each other to operatively control the magnet 450 passing through the coil passage. The sensing unit 470 and the electric current source 480 can also operate independently. The sensing unit 470 and the electric current source 480 include processing circuitry such as hardware which processes executable instructions such as software. In an embodiment, the coil 460 can be coupled to the distal end of or to another location on the stop arm 440 and the magnet 450 can be fixedly attached to another portion of the coin control system 400 so that coil 460 forming the coil passage moves to receive the magnet 450.

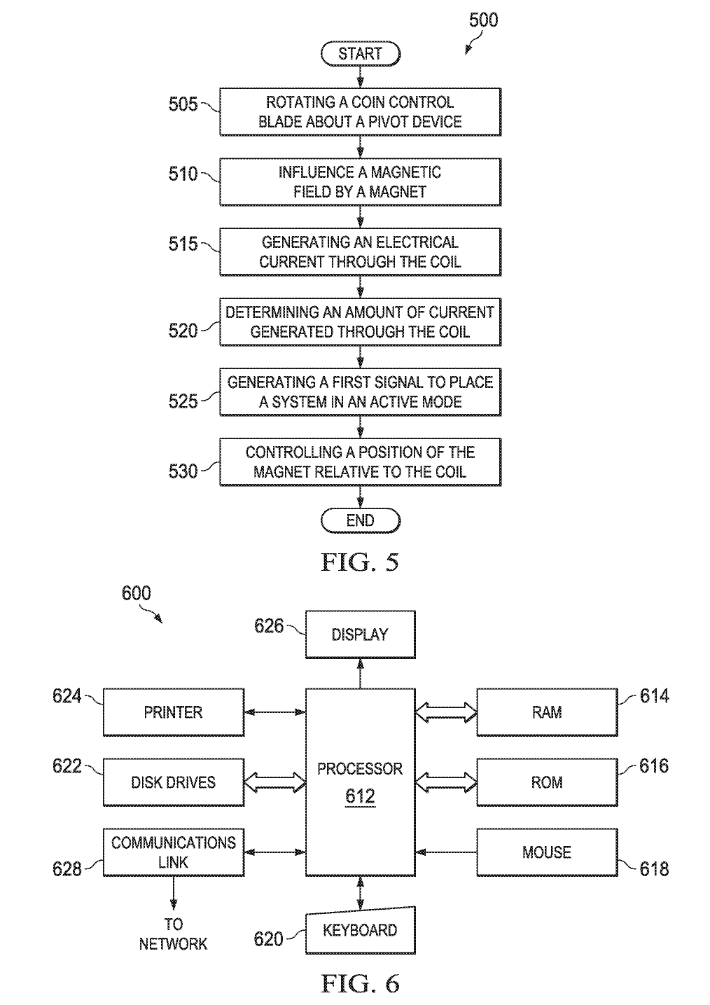

FIG. 5 illustrates an example process 500 to operate a coin control system 400 according to this disclosure. The process 500 described with reference to FIG. 5 can be executed by a processor, processing circuitry, or controller electrically coupled to the coin control system 400 of FIG. 4. The various operations below may be performed by a processor, controller, processing circuitry, or a combination while in connection with a memory element.

At operation 505, the coin control system 400 receives a force (for example, caused by the insertion of coin into the coin control system 400) causing a coin control blade 410 to rotate around a pivot device 420. A stop arm 440 with a magnet 450 disposed on the distal end of the stop arm 440 rotates about the pivot device 420 in response to the rotation of the coin control blade 410. A stop arm 440 with a magnet 450 disposed on the distal end of the stop arm 440 rotates about the pivot device 420 in cooperation with the rotation of the coin control blade 410. At operation 510, after the stop arm 440 rotates about the pivot device 420, the magnet 450 influences the magnetic field in a coil 460. At operation 515, an electric current is generated through the coil 460 in response to the magnet 450 passing through the coil passage formed by the coil 460.

At operation 520, a sensing unit 470 determines an amount of electric current generated through the coil 460 by the passage of the magnet 450 through the coil passage. The sensing unit 470 can transmit a wake-up signal to the coin control system 400 in response to sensing any amount of electric current through the coil 460. The wake-up signal transitions the coin control system 400, vending machine 100, and the like, from the off-mode or power saving mode 497 into the active mode 498.

At operation 525, the sensing unit 470 transmits a wake-up signal to activate the coin control system 400 in response to sensing an electric current through the coil 460 that is above an electric current threshold. This can, for example, prevent objects (such as fingers, which may not fit as far through a coin slot as a coin) from activating the coin control system 400. A finger, for example, may not be able to cause the magnet 450 to pass through the coil 460 with enough velocity to generate an electric current that is above a threshold. The coin control system 400 could remain in an off-mode or a power saving mode even though electric current (such as below the electric current threshold), even if a small amount, is generated through the coil 460.

At operation 530, the sensing unit 470 determines an amount of electric current generated through the coil 460 by the magnet 450 to control the electric current source 480 to control a position of the magnet 450 relative to the coil 460. For example, the sensing unit 470 can determine the amount of electric current generated through the coil 460 by the magnet 450 and control the electric current source 480 to generate a counter electric current through the coil to dampen the movement of the magnet 450 through the coil 460 or stop the movement of the magnet 450 through the coil 460.

The sensing unit 470 can control the electric current source 480 to generate an electric current through the coil 460 when the magnet 450 begins to move out of the coil passage formed by the coil 460. This electric current holds the magnet 450 in a temporary static position with the coil passage. The coin control blade 410 could then remain in an open position for a predetermined period of time after the insertion of coin to ensure that even the smallest coin does not get trapped under or with the coin control blade 410.

In one embodiment, an electronic transaction system includes a control blade configured to rotate about a pivot. The electronic transaction system also includes an arm coupled to the control blade at the pivot. The arm is configured to rotate about the pivot. The electronic transaction system also includes a permanent magnet disposed at a distal end of the arm opposite the pivot. The electronic transaction system also includes an electrically conducting coil forming a coil passage. The coil passage is configured to receive the permanent magnet. The electronic transaction system also includes a sensing unit comprising processing circuitry configured to sense an electric current through the coil and generate a signal in response to sensing the electric current through the coil.

FIG. 6 is an embodiment of a general-purpose computer 600—components of which that may be used in connection with other embodiments of the disclosure to carry out any of the above-referenced functions and/or serve as components for a coin control system 400 illustrated in FIG. 4. General-purpose computer 600 may generally be adapted to execute any of the known OS2, UNIX, Mac-OS, Linux, Android and/or Windows Operating Systems or other operating systems. The general purpose computer 600 in this embodiment includes a processor 612, a random access memory (RAM) 614, a read only memory (ROM) 616, a mouse 618, a keyboard 620, and input/output devices such as a printer 624, disk drives 622, a display 626 and a communications link 628. In other embodiments, the general-purpose computer 600 may include more, less, or other component parts. Embodiments of the present disclosure may include programs that may be stored in the RAM 614, the ROM 616 or the disk drives 622 and may be executed by the processor 612 in order to carry out functions described herein. The processor 612 can include a controller, processing circuitry, and the like. Further, the processor or 612 can include or control any module, component, engine, and/or unit described herein. The communications link 628 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding. Disk drives 622 may include a variety of types of storage media such as, for example, floppy disk drives, hard disk drives, CD ROM drives, DVD ROM drives, magnetic tape drives or other suitable storage media. Although this embodiment employs a plurality of disk drives 622, a single disk drive 622 may be used without departing from the scope of the disclosure.

Although FIG. 6 provides one embodiment of a computer that may be utilized with other embodiments of the disclosure, such other embodiments may additionally utilize computers other than general-purpose computers as well as general-purpose computers without conventional operating systems. Additionally, embodiments of the disclosure may also employ multiple general-purpose computers 600 or other computers networked together in a computer network. Most commonly, multiple general-purpose computers 600 or other computers may be networked through the Internet and/or in a client server network. Embodiments of the disclosure may also be used with a combination of separate computer networks each linked together by a private or a public network.

Several embodiments of the disclosure may include logic contained within a medium. In the embodiment of FIG. 6, the logic includes computer software executable on the general-purpose computer 600. The medium may include the RAM 614, the ROM 616, the disk drives 622, or other mediums. In other embodiments, the logic may be contained within hardware configuration or a combination of software and hardware configurations.

The logic may also be embedded within any other suitable medium without departing from the scope of the disclosure.

It will be understood that well known processes have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC § 112 unless the exact words “means for” are followed by a participle.

1. An apparatus, comprising:
a control blade configured to move by rotating or translating;
a magnet coupled to the control blade; and
an electric coil,
wherein the magnet is positioned such that movement of the control blade causes the magnet to influence an electromagnetic field of the electric coil.

2. The apparatus of claim 1, further comprising:
a stop arm coupled to the control blade and configured to move with the control blade, wherein the magnet is coupled to the stop arm of the control blade.

3. The apparatus of claim 1, further comprising:
a sensor configured to sense an electric current in the electric coil, wherein the electric current is produced when the magnet influences the electromagnetic field of the electric coil.

4. The apparatus of claim 3, further comprising:
at least one processor configured to control the movement of the control blade using an interaction between the magnet and the electric coil.

5. The apparatus of claim 2, wherein the magnet is coupled to a distal end of the stop arm opposite from a pivot.

6. The apparatus of claim 4, wherein the at least one processor configured to control the movement of the control blade using the interaction between the magnet and the electric coil comprises the at least one processor configured to:
receive an amount of an electric current from the sensor;
determine whether the amount of the electric current exceeds a threshold current; and
responsive to the electric current exceeding the threshold current, send a command to the apparatus to enter an active mode.

7. The apparatus of claim 6, further comprising:
a current source configured to produce a counter electric current that is opposite to the electric current of the electric coil.

8. The apparatus of claim 7, wherein the at least one processor is further configured to, responsive to the electric current exceeding the threshold current, control the current source to produce the counter electric current to counter at least a portion of the electric current.

9. The apparatus of claim 6, further comprising:
a current source configured to produce an additional electric current that is a same as the electric current of the electric coil.

10. The apparatus of claim 9, wherein the at least one processor is further configured to:
identify a reduction in the electric current; and
control the current source to produce the additional electric current to increase the electric current.

11. The apparatus of claim 1, further comprising:
at least one processor configured to receive an amount of an electric current from a sensor and determine a type of coin based on the amount of the electric current.

12. A method for controlling a coin mechanism, comprising:
receiving an amount of an electric current from a sensor indicating a movement by rotation or translation of a control blade, wherein the electric current is produced from an electric coil when a magnet coupled to the control blade influences an electromagnetic field of the electric coil; and
controlling the movement of the control blade using an interaction between the magnet and the electric coil.

13. The method of claim 12, wherein a stop arm is coupled to the control blade and configured to pivot with the control blade, and wherein the magnet is coupled to the stop arm of the control blade.

14. The method of claim 12, wherein a sensor is configured to sense the electric current in the electric coil.

15. The method of claim 13, wherein the magnet is coupled to a distal end of the stop arm opposite from the pivot.

16. The method of claim 12, wherein controlling the movement of the control blade using the interaction between the magnet and the electric coil comprises:
receiving an amount of an electric current from the sensor;
determining whether the amount of the electric current exceeds a threshold current; and
responsive to the electric current exceeding the threshold current, sending a command to the coin mechanism to enter an active mode.

17. The method of claim 16, further comprising:
responsive to the electric current exceeding the threshold current, producing a counter electric current to counter at least a portion of the electric current.

18. The method of claim 19, further comprising:
identifying a reduction in the electric current; and
producing an additional electric current to increase the electric current.

19. The method of claim 12, further comprising:
determining a type of coin based on the amount of the electric current.

20. A coin recognition system, comprising:
an enclosure including a payment access mechanism, wherein the payment access mechanism comprises a coin mechanism, and wherein the coin mechanism comprises:
a control blade configured to move by rotation or translation;
a magnet coupled to the control blade; and
an electric coil,
wherein the magnet is positioned such that movement of the control blade causes the magnet to pass influence an electromagnetic field of the electric coil.
